(19) United States
(12) Patent Application Publication
(10) Pub. No.: US 2015/0148454 A1
(43) Pub. Date: May 28, 2015

(54) POLYESTER COMPOSITIONS

(71) Applicant: LANXESS Deutschland GmbH, Cologne (DE)

(72) Inventors: Timo IMMEL, Dormagen (DE); Jochen ENDTNER, Cologne (DE); Matthias BIENMUELLER, Krefeld (DE)

(21) Appl. No.: 14/548,944

(22) Filed: Nov. 20, 2014

(30) Foreign Application Priority Data
Nov. 27, 2013 (EP) 13194640.2
Jan. 18, 2014 (DE) 102014000613.1
Jun. 13, 2014 (EP) 14172375.9

(51) Int. Cl. C08L 67/02; B29B 9/14; B29B 7/00; B29C 45/00; B29C 47/00

(52) U.S. Cl. CPC C08L 67/02; B29C 45/0001; B29C 47/0004; B29B 7/002; B29B 9/14; B29K 2067/003
USPC 523/466; 524/451; 524/94; 524/126; 524/101; 524/97; 524/109; 524/343; 524/344; 524/171; 264/294; 264/176.1

(57) ABSTRACT

The invention relates to compositions, especially thermoplastic moulding compositions, comprising polyethylene terephthalate (PET), poly(1,4-cyclohexanedimethanol terephthalate) (PCT), glass fibres and talc, to the use of these compositions in the form of moulding compositions for production of products resistant to heat distortion for short periods, and to a process for producing polyester-based products resistant to heat distortion for short periods, preferably polyester-based electric or electronic products, especially polyester-based optoelectronic products.

The invention relates to compositions, especially thermoplastic moulding compositions, comprising polyethylene terephthalate (PET), poly(1,4-cyclohexanedimethanol terephthalate) (PCL), talc and glass fibres, to the use of these compositions in the form of moulding compositions for production of products resistant to heat distortion for short periods, and to a process for producing polyester-based electric or electronic products resistant to heat distortion for short periods, especially polyester-based optoelectronic products.

### PRIOR ART

Many electronic and electric assemblies and components include thermally sensitive electric and/or electronic products, particularly heat-sensitive integrated circuits, lithium batteries, oscillator crystals and optoelectronic products. In the course of installation of such an assembly, the electrical contacts provided on the products have to be connected in a reliable processing method to conductor tracks on a circuit board and/or to electrical contacts on other products. This installation is frequently effected with the aid of a soldering method, in which solder connections provided on the product are soldered to the circuit board. For each product, there is a safe range for the solder time and soldering temperature, in which good solder connections can be produced. In order to achieve a good solder result, the products have to be exposed to elevated temperatures during the soldering over prolonged periods. For example, in the course of wave soldering, the product inserted into the circuit board is first heated gradually to about 100-130° C. This is followed by the actual soldering, which is typically effected at 260 to 285° C. and takes at least 5 seconds, followed by the solidification phase during which the product cools down gradually over several minutes.

According to “http://de.wikipedia.org/wiki/%C3% B6ten”, wave soldering, also referred to as flow soldering, is a soldering method by which electronic assemblies (circuit boards, flat assemblies) can be soldered in a semiautomatic or fully automatic manner after fitting. The solder side of the circuit board is first wetted with a flux in the fluxer. Thereafter, the circuit board is preheated by means of convection heating (swirling of the heat, as a result of which the same temperature is present virtually everywhere, even on the upper side), coil heating or infrared radiators. This is done firstly in order to vaporize the solvent content of the flux (otherwise bubbles will be formed in the soldering operation), to increase the chemical efficacy of the activators used, and to avoid thermal warpage of the assembly and damage to the components as a result of an excessively steep temperature rise in the course of subsequent soldering. In general, a temperature differential of less than 120° C. Is required. This means that the circuit board has to be heated to at least 130° C. in the case of a soldering temperature of 250° C.

Exact data are found through temperature profiles. This involves mounting temperature sensors at relevant points on a specimen circuit board and recording with a measuring instrument. This gives temperature curves for the upper and lower sides of the circuit board for selected components. Thereafter, the assembly is run over one or two solder waves. The solder wave is generated by pumping liquid solder through an orifice. The soldering temperature is about 250° C. in the case of lead-containing solders, and about 10° C. to 35° C. higher in the case of lead-free solders which are preferred due to the avoidance of lead-containing vapours, i.e. 260° C. to 285° C.

The solder time should be selected such that the heating damages neither the circuit board nor the heat-sensitive components. The solder time is the contact time with the liquid solder per solder site. The guideline times for circuit boards laminated on one side are less than one second, and for circuit boards laminated on both sides not more than two seconds. In the case of multiple circuit boards, individual solder times of up to six seconds apply. According to DIN EN 61760-1: 1998, the maximum period for one wave or else two waves together is 10 seconds. More specific details can be taken from the abovementioned reference. After the soldering, cooling of the assembly is advisable, in order to rapidly reduce the thermal stress again. This is accomplished via direct cooling by means of a cooling unit (climate control system) immediately downstream of the soldering region and/or by means of conventional ventilators in the sink station or a cooling tunnel on the return belt.

The result is high demands in terms of short-term heat distortion resistance on the materials used, especially for the lead-free solders which have elevated melting temperatures and are being used ever more frequently for environmental reasons. In addition, materials of this kind must have very good ageing resistance under the temperatures that occur in use.

Thermoplastic polyesters such as polybutylene terephthalate (PBT) and polyethylene terephthalate (PET) are particularly suitable for electrics and electronics applications because of their good processability, low water absorption and associated high dimensional stability, and colour stability at high temperatures, but particularly because of their outstanding electrical properties. However, thermoplastic polyesters such as PBT and PET, because of their melting points of 220° C. and 260° C. respectively, rapidly hit their limits specifically in soldering operations with short-term peak temperatures above these melting points.

A useful thermoplastic polyester having a melting point of 285° C. for wave soldering would in principle be poly(1,4-cyclohexylenedimethylene) terephthalate (PCT). For instance, WO 2007/033129 A1 describes thermally stable compositions for LED housings based on PCT, and also titanium dioxide and glass fibres. It is problematic here, however, that the mechanical properties of PCT are inferior to those of PBT or PET, and it is more difficult to process because it is slower to crystallize. Because of the high processing temperatures dictated by the high melting point, the choice of suitable additives is also very restricted, which applies particularly to the range of flame retardants, and very particularly to the nitrogen- and phosphorus-based halogen-free flame retardants, which are frequently relatively thermally sensitive.

WO 2010/049531 A1 discloses, as an example of electrics and electronics applications, what are called power LEDs based on aromatic polyesters or fully aromatic polyesters, which are said to prevent the degradation of the thermoplastic material by heat or radiation. The use of these aromatic polyesters or fully aromatic polyesters, especially based on p-hydroxybenzoic add, terephthalic acid, hydroquinone or 4,4′-bisphenol, and optionally isophthalic acid, leads to a longer-lasting lighting performance of these power LEDs. One disadvantage of the polyesters of WO 2010/049531 A1 here too, however, is the high processing temperature in the melt, which is at temperatures of 355° C. or higher because of the high melting points of the polymers described, and another is the high mould temperatures of 175° C. or higher. High processing temperatures and mould temperatures restrict the selection of further additives, especially the selection of usable flame retardants, and additionally require injection moulding machines specially modified in a costly manner, especially in the heating and cooling of the moulds. Moreover, high processing temperatures lead to increased wear on the injection moulding unit.

U.S. Pat. No. 4,874,809 describes glass fibre-reinforced polyesters comprising polyethylene terephthalate (PET) and poly(1,4-cyclohexanedimethanol terephthalate) (PCT), to which have been added between 5% by weight and 50% by weight of mica in order to reduce the tendency to warpage. However, no advantages were demonstrated therein with regard to improved short-term heat distortion resistance or else lower processing temperatures. Another problem which can be identified here is the obligatory use of at least 5% by weight of mica, which can adversely affect the profile of properties, especially in terms of mechanical properties. According to “http://de.wikipedia.org/wiki/Glimmergruppe”, mica refers to a group of sheet silicates having the chemical composition D G₂₃ [T₄O₁₀]X₂, in which

D represents 12-coordinated cations, especially K, Na, Ca, Ba, Rb, Cs, NH₄⁺,
G represents 6-coordinated cations, especially Li, Mg, Fe²⁺, Mn, Zn, Al, Fe³⁺, Cr, V, Ti,
T represents 4-coordinated cations, especially Si, Al, Fe³⁺, B, Be, and
X represents an anion, especially OH⁻, F⁻, Cl⁻, O²⁻, S²⁻.

The problem addressed by the present invention was therefore that of providing compositions, especially thermoplastic compositions, based on thermoplastic polyesters which have an improved short-term heat distortion resistance compared to PBT and PET on the one hand, but are processable at the low temperatures characteristic of PBT and PET on the other hand, and as a result have fewer restrictions in the selection of additives, especially flame retardants, and have good mechanical properties.

Good mechanical properties in the context of the present invention, with regard to the products to be produced in accordance with the invention, feature high values in the Izod impact resistance, and high flexural strength and edge fibre elongation. Impact resistance describes the ability of a material to absorb impact energy and shock energy without fracturing. The testing of Izod impact resistance to ISO 180 is a standard method for determining the impact resistance of materials. This involves first holding an arm at a particular height (=constant potential energy) and finally releasing it. The arm hits the sample, fracturing it. The impact energy is determined from the energy which is absorbed by the sample. Impact resistance is calculated as the ratio of impact energy and sample cross section (unit of measurement: kJ/m²). Flexural strength in technical mechanics is a value for a flexural strength which, when exceeded in a component under flexural stress, causes failure as a result of fracture of the component. It describes the resistance that a workpiece offers to flexing or fracture thereof. In the short-term bending test to ISO 178, bar-shaped specimens, preferably having the dimensions 80 mm·10 mm·4 mm, are placed with their ends on two supports and loaded with a flexing ram in the middle. The forces and deflections found are used to calculate the characteristic values of flexural strengths and edge fibre elongation (Bodo Carlowitz: Tabellarische Übersicht Über die PrÜfung von Kunststoffen [Tabular Overview of the Testing of Plastics], 6th edition, Giesel-Verlag für Publizität, 1992, p. 16-17).

### INVENTION

The solution to the problem and the subject-matter of the present invention are compositions, especially thermoplastic moulding compositions and products that can be produced therefrom, comprising

a) poly(1,4-cyclohexylenedimethylene) terephthalate (PCT),
b) polyethylene terephthalate (PET),
c) glass fibres, and
d) talc, preferably microcrystalline talc.

For clarity, it should be noted that the scope of the present invention encompasses all the definitions and parameters mentioned hereinafter in general terms or specified within areas of preference, in any desired combinations. In addition, for clarity, it should be noted that the compositions, in a preferred embodiment, may be mixtures of components a), b), c) and d), and also thermoplastic moulding compositions that can be produced from these mixtures by means of processing operations, preferably by means of at least one mixing or kneading apparatus, but also products that can be produced from these in turn, especially by extrusion or injection moulding. Unless stated otherwise, all figures are based on room temperature (RT)=23+/−2° C. and on standard pressure=1 bar.

The preparation of the compositions according to the present invention for further use or application takes place by mixing components a), b), c) and d) to be used as educts in at least one mixing tool. Mouldings are obtained as intermediate products and based on the compositions according to the present invention. These mouldings can exist either exclusively of the components a), b), c) and d), or include, however, in addition, to the components a), b), c) and d) even other components. In this case the components a), b), c) and d) are to be varied within the scope of the given amount areas in such way that the sum of all weight percent always results in 100.

In the case of thermoplastic moulding compositions and products that can be produced therefrom, the proportion of the inventive compositions therein is preferably in the range from 50 to 100% by weight, the other constituents being additives selected by those skilled in the art in accordance with the later use of the products, preferably from at least one of components e) to h) defined hereinafter.

### PREFERRED EMBODIMENTS OF THE INVENTION

The present invention preferably provides compositions, especially thermoplastic moulding compositions, comprising
a) 3 to 30% by weight, preferably 5 to 25% by weight, more preferably 10 to 20% by weight, of poly(1,4-cyclohexylenedimethylene) terephthalate (PCT), where the proportion of PCT based on the sum total of all the thermoplastic polymers present in the composition is in the range from 5 to 40% by weight, preferably 7 to 30% by weight, more preferably 10-25% by weight,
b) 15 to 91.99% by weight, preferably 20 to 70% by weight, more preferably 30 to 60% by weight, of polyethylene terephthalate (PET),
c) 5 to 70% by weight, preferably 10 to 45% by weight, more preferably 15 to 35% by weight, of glass fibres, and
d) 0.01 to 10% by weight, preferably 0.05 to 5% by weight, more preferably 0.1 to 2% by weight, of talc, preferably microcrystalline talc,
   where the individual components should be combined with one another in such a way that the sum total of all the percentages by weight is 100.

In a preferred embodiment, the present invention relates to compositions, especially thermoplastic moulding compositions, comprising, in addition to components a), b), c) and d), also e) at least one flame retardant, preferably 1 to 50% by weight, more preferably 5 to 30% by weight, most preferably 10 to 20% by weight, of at least one flame retardant, in which case the level of at least one of the other components should be reduced to such an extent that the sum total of all the percentages by weight is 100.

In a preferred embodiment, the inventive compositions, especially thermoplastic moulding compositions, in addition to components a) to e) or instead of component e), also comprise f) at least one additive having at least two epoxy groups per molecule, preferably 0.01 to 10% by weight, more preferably 0.1 to 7% by weight, most preferably 0.5 to 5% by weight, of at least one additive having at least two epoxy groups per molecule, in which case the level of at least one of the other components should be reduced to such an extent that the sum total of all the percentages by weight is 100.

In a preferred embodiment, the inventive compositions, especially thermoplastic moulding compositions, in addition to components a) to f) or instead of components e) and/or f), also comprise g) titanium dioxide, preferably 0.01 to 30% by weight, more preferably 1 to 25% by weight, most preferably 5 to 20% by weight, of titanium dioxide, in which case the level of at least one of the other components should be reduced to such an extent that the sum total of all the percentages by weight is 100.

In a preferred embodiment, the inventive compositions, especially thermoplastic moulding compositions, in addition to components a) to g) or instead of components e) and/or f) and/or g), also comprise h) at least one other additive different from components c) to g), preferably 0.01 to 15% by weight, more preferably 0.1 to 10% by weight, most preferably 0.1 to 5% by weight, of at least one other additive different from components c) to g), in which case the level of at least one of components a) to g) should be reduced to such an extent that the sum total of all the percentages by weight is 100.

### Component a)

According to the invention, a blend of component a) PCT (CAS No. 24936-69-4) and component b) PET is used. PCT for use with preference has an intrinsic viscosity in the range from about 30 cm³/g to 150 cm³/g, more preferably in the range from 40 cm³/g to 130 cm³/g, especially preferably in the range from 60 cm³/g to 120 cm³/g, in each case measured in analogy to ISO 1628-1 in phenol/o-dichlorobenzene (1:1 parts by weight) at 25° C. in an Ubbelohde viscometer. Intrinsic viscosity [η] is also called the limiting viscosity number or Staudinger index, since it is firstly a material constant and secondly is related to the molecular weight. It indicates how the viscosity of the solvent is affected by the dissolved substance. Intrinsic viscosity is determined using the following definition:

$$[ η ] = {lim}_{c -> 0} \frac{{η}_{sp}}{c} = {lim}_{c -> 0} \frac{1}{c} ln ( \frac{η}{{η}_{0}} )$$

where c is the concentration of the dissolved substance in g/ml, η₀ is the viscosity of the pure solvent and

$${η}_{sp} = \frac{η}{{η}_{0}} - 1$$

is the specific viscosity. The viscosity is measured by drying the material to a moisture content of not more than 0.02% by weight, determined by means of the Karl Fischer method known to those skilled in the art, in a commercial air circulation dryer at 120° C. (see: http://de.wikipedia.org/wiki/Karl-Fischer-Verfahren).

### Component b)

The PET (CAS No. 25038-59-9) for use as component b) is a reaction product of aromatic dicarboxylic acids or the reactive derivatives thereof, preferably dimethyl esters or anhydrides, and aliphatic, cycloaliphatic or araliphatic diols and mixtures of these reactants. PET can be prepared from terephthalic acid (or the reactive derivatives thereof) and the particular aliphatic diols having 2 or 4 carbon atoms by known methods (Kunststoff-Handbuch [Plastics Handbook], vol. VIII, p. 695-703, Karl-Hanser-Verlag, Munich 1973).

PET for use with preference as component b) contains at least 80 mol %, preferably at least 90 mol %, based on the dicarboxylic acid, of terephthalic acid residues and at least 80 mol %, preferably at least 90 mol %, based on the diol component, of ethylene glycol residues.

PET for use with preference as component b) may contain, as well as terephthalic acid residues, up to 20 mol % of residues of other aromatic dicarboxylic acids having 8 to 14 carbon atoms or residues of aliphatic dicarboxylic acids having 4 to 12 carbon atoms, preferably residues of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid or cyclohexanedicarboxylic acid.

PET for use with preference as component b) may, as well as ethylene glycol or butane-1,4-diol glycol residues, contain up to 20 mol % of other aliphatic diols having 3 to 12 carbon atoms or cycloaliphatic diols having 6 to 21 carbon atoms. Preference is given to residues of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,6-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane or 2,2-bis(4-hydroxypropoxyphenyl)propane (DE-A 24 07 674 (=U.S. Pat. No. 4,035,958), DE-A 24 07 776, DE-A 27 15 932 (=U.S. Pat. No. 4,176,224)).

In one embodiment, the PET for use as component b) in accordance with the invention may be branched through incorporation of relatively small amounts of tri- or tetrahydric alcohols or tri- or tetrabasic carboxylic acids, as described, for example, in DE-A 19 00 270 (=U.S. Pat. No. 3,692,744). Preferred branching agents are trimesic acid, trimellitic acid, trimethylolethane and trimethylolpropane, and pentaerythritol.

The PET for use with in accordance with the invention preferably has an intrinsic viscosity in the range from about 30 cm³/g to 150 cm³/g, more preferably in the range from 40 cm³/g to 130 cm³/g, especially preferably in the range from 50 cm³/g to 100 cm³/g, in each case measured in analogy to ISO 1628-1 in phenol/o-dichlorobenzene (1:1 parts by weight) at 25° C. by means of an Ubbelohde viscometer.

The polyesters of component a) PCT and/or component b) PET may, in one embodiment, optionally also be used in a mixture with other polyesters, especially PBT, and/or further polymers. The preparation of polyesters of components a) and b) is also described, for example, in Ullmanns Enzyclopädie der technischen Chemie [Ullmann's Encyclopedia of Industrial Chemistry], 4th edition, volume 19, pages 65 ff., Verlag Chemie, Weinheim 1980.

### Component c)

According to “http://de.wikipedia.org/wiki/Faser-Kunststoff-Verbund”, chopped fibres, also referred to as short fibres, having a length in the range from 0.1 to 1 mm, are distinguished from long fibres having a length in the range from 1 to 50 mm and continuous fibres having a length L>50 mm. Short fibres are used in injection moulding technology and can be processed directly in an extruder. Long fibres can likewise still be processed in extruders. They are used on a large scale in fibre injection moulding. Long fibres are frequently added to thermosets as a filler. Continuous fibres are used in the form of rovings or fabric in fibre-reinforced plastics. Products comprising continuous fibres achieve the highest stiffness and strength values. Additionally supplied are ground glass fibres having a length after grinding typically in the range from 70 to 200 μm.

Preference is given in accordance with the invention to using, for component c), chopped long glass fibres having a starting length in the range from 1 to 50 mm, more preferably in the range from 1 to 10 mm, most preferably in the range from 2 to 7 mm. The glass fibres of component c) may, as a result of the processing to give the moulding composition or to give the product, have a lower d97 or d50 value in the moulding composition or in the product than the glass fibres originally used. Thus, the arithmetic mean of the glass fibre length after processing is frequently only in the range from 150 μm to 300 μm.

The glass fibre length and glass fibre length distribution are determined in the context of the present invention, in the case of processed glass fibres, in analogy to ISO 22314, which first stipulates ashing of the samples at 625° C. Subsequently, the ash is placed onto a microscope slide covered with demineralized water in a suitable crystallizing dish, and the ash is distributed in an ultrasound bath with no action of mechanical forces. The next step involves drying in an oven at 130° C., followed by the determination of the glass fibre length with the aid of light microscopy images. For this purpose, at least 100 glass fibres are measured in three images, and so a total of 300 glass fibres are used to ascertain the length. The glass fibre length either can be calculated as the arithmetic mean lₙ according to the equation

$${l}_{n} = \frac{1}{n} \cdot {\sum }_{i}^{η} {l}_{i}$$

where lᵢ=length of the ith fibre and n=number of fibres measured, and be shown in a suitable manner as a histogram, or, in the case that a normal distribution of the glass fibre lengths l measured is assumed, can be determined with the aid of the Gaussian function according to the equation

$$f ( l ) = \frac{1}{\sqrt{2 π} \cdot σ} \cdot {e}^{- \frac{1}{2} {( \frac{i - {l}_{c}}{σ} )}^{2}}$$

Here, l_{c} and σ are specific characteristic values in the normal distribution; l_{c} is the median value and σ the standard deviation (see: M. Schoβig, Schädigungsmechanismen in faserverstärkten Kunststoffen [Damage Mechanisms in Fibre-Reinforced Plastics], 1, 2011, Vieweg und Teubner Verlag, page 35, ISBN 978-3-8348-1483-8). Glass fibres not incorporated into a polymer matrix are analysed with respect to their lengths by the above methods, but without processing by ashing and separation from the ash.

The glass fibres may, as a result of the processing to give the moulding composition or the product to be produced therefrom, have a lower d97 or d50 value in the moulding composition or in the product in relation to their length than the glass fibres originally used.

The glass fibres used in accordance with the invention as component c) (CAS No. 65997-17-3) preferably have a mean fibre diameter in the range from 7 to 18 μm, more preferably in the range from 9 to 15 μm, which can be determined by at least one method available to those skilled in the art, and can especially be determined by μ-x-ray computer tomography in analogy to “Quantitative Messung von Faserlängen und-verteilung in faserverstärkten Kunststoffteilen mittels μ-Röntgen-Computertomographie” [Quantitative Measurement of Fibre Length and Distribution in Fibre-Reinforced Plastics Parts by Means of μ-X-Ray Computer Tomography], J. KASTNER, et al. DGZIP Annual Meeting 2007—Presentation 47. The glass fibres for use as component c) are added in the form of continuous fibres or in the form of chopped or ground glass fibres.

The fibres are preferably modified with a suitable slip system and an adhesion promoter or adhesion promoter system, more preferably based on silane.

Very particularly preferred silane-based adhesion promoters, especially for the pretreatment of the glass fibres, are silane compounds of the general formula (I)

(X—(CH₂)_{q})ₖ—Si—(O—CᵣH₂ᵣ₊₁)₄₋ₖ (I)

in which the substituents are defined as follows:

### X: NH₂—, HO—,

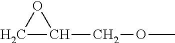

q: an integer from 2 to 10, preferably 3 to 4,
r: an integer from 1 to 5, preferably 1 to 2,
k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane, and the corresponding silanes containing a glycidyl group as the X substituent.

For the modification of the glass fibres, the silane compounds are preferably used in amounts of 0.05% to 2% by weight, more preferably 0.25% to 1.5% by weight and especially 0.5% to 1% by weight, based on the glass fibres for surface coating.

The glass fibres may, as a result of the processing to give the moulding composition or the product to be produced therefrom, have a lower d97 or d50 value in the moulding composition or in the product than the glass fibres originally used. The glass fibres may, as a result of the processing to give the moulding composition or shaped bodies, have shorter length distributions in the moulding composition or in the shaped body than originally used.

### Component d)

According to the invention, talc is used as component d), preferably microcrystalline talc. Talc (CAS No. 14807-96-6) is a sheet silicate having the chemical composition Mg₃[Si₄O₁₀(OH)₂], which, according to the polymorph, crystallizes as talc-1A in the triclinic crystal system or as talc-2M in the monoclinic crystal system (http://de.wikipedia.org/wiki/Talkum).

Microcrystalline talc in the context of the present invention is described in WO 2014/001158 A1, the contents of which are fully encompassed by the present disclosure. In one embodiment of the present invention, microcrystalline talc having a median particle size d50 determined using a SediGraph in the range from 0.5 to 10 μm is used, preferably in the range from 1.0 to 7.5 μm, more preferably in the range from 1.5 to 5.0 μm and most preferably in the range from 1.8 to 4.5 μm.

As described in WO 2014/001158 A1, in the context of the present invention, the particle size of the talc for use in accordance with the invention is determined by sedimentation in a fully dispersed state in an aqueous medium with the aid of a “Sedigraph 5100” as supplied by Micrometrics Instruments Corporation, Norcross, Ga., USA. The Sedigraph 5100 delivers measurements and a plot of cumulative percentage by weight of particles having a size referred to in the prior art as “equivalent sphere diameter” (esd), minus the given esd values.

The median particle size d50 is the value determined from the particle esd at which 50% by weight of the particles have an equivalent sphere diameter smaller than this d50 value. The underlying standard is ISO 13317-3.

In one embodiment, microcrystalline talc is defined via the BET surface area. Microcrystalline talc for use in accordance with the invention preferably has a BET surface area, which can be determined in analogy to DIN ISO 9277, in the range from 5 to 25 m²·g⁻¹, more preferably in the range from 10 to 18 m²·g⁻¹, most preferably in the range from 12 to 15 m²·g⁻¹.

Microcrystalline talc for use with very particular preference in accordance with the invention can be purchased, for example, as Mistron® Rio from Imerys Talc Group, Toulouse, France (Rio Tinto Group) with a median particle size to ISO 13317-3 d50=1.9 μm and a BET to DIN ISO 9277 of 15 m²·g·⁻¹, or as V3902 from Luzenac Europe SAS (nowadays likewise Imerys Talc Group) having a d50 to ISO 13373-3 of 2.2 μm and a BET of 14.5 m²·g⁻¹.

### Component e)

According to the invention, at least one flame retardant is used as component e). Preferred flame retardants are commercial organic halogen compounds with or without synergists or commercial halogen-free flame retardants based on organic or inorganic phosphorus compounds or organic nitrogen compounds, individually or in a mixture.

Halogenated, especially brominated or chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A ollgocarbonate, polypentabromobenzyl acrylate, brominated polystyrene or brominated polyphenylene ether. Suitable phosphorus compounds include the phosphorus compounds according to WO A 98/17720 (=U.S. Pat. No. 6,538,024), preferably metal phosphinates, especially aluminium phosphinate or zinc phosphinate, metal phosphonates, especially aluminium phosphonate, calcium phosphonate or zinc phosphonate and the corresponding hydrates of the metal phosphonates, and also derivatives of the 9,10-dihydro-9-oxa-10-phosphaphenanthrene 10-oxides (DOPO derivatives), triphenyl phosphate (TPP), resorcinol bis(diphenyl phosphate) (RDP), including oligomers, and bisphenol A bis(diphenyl phosphate) (BDP) including oligomers, polyphosphonates (for example Nofia® HM1100 from FRX Polymers, Chelmsford, USA), and also zinc bis(diethylphosphinate), aluminium tris(diethylphosphinate), melamine phosphate, melamine pyrophosphate, melamine polyphosphate, melamine poly(aluminium phosphate), melamine poly(zinc phosphate) or phenoxyphosphazene oligomers and mixtures thereof. Useful nitrogen compounds include especially melamine or melamine cyanurate and reaction products of trichlorotriazine, piperazine and morpholine as per CAS No. 1078142-02-5 (e.g. MCA PPM Triazine HF from MCA Technologies GmbH, Biel-Benken, Switzerland). Suitable synergists are preferably antimony compounds, especially antimony trioxide or antimony pentoxide, zinc compounds, tin compounds, especially zinc stannate, or borates, especially zinc borates, and it is also possible to use synergistic combinations of various flame retardants.

It is also possible to add what are called carbon formers, especially polyphenylene ether, and anti-dripping agents, especially tetrafluoroethylene polymers, to the flame retardant.

Among the halogenated flame retardants, particular preference is given to using ethylene-1,2-bistetrabromophthalimide, tetrabromobisphenol A oligocarbonate, polypentabromobenzyl acrylate or brominated polystyrene, for example Firemaster® PBS64 (Great Lakes, West Lafayette, USA), in each case in combination with antimony trioxide and/or aluminium tris(dethylphosphlnate).

Among the halogen-free flame retardants, particular preference is given to using aluminium tris(diethylphosphinate) (CAS No. 225789-38-8), in combination with melamine polyphosphate (CAS No. 41583-09-9) (e.g. Melapur® 200/70 from BASF SE, Ludwigshafen, Germany) and/or melamine cyanurate (CAS No. 37640-57-6) (e.g. Melapur® MC25 from BASF SE, Ludwigshafen, Germany) and/or phenoxyphosphazene oligomers (CAS No. 28212-48-8) (e.g. Rabitle® FP110 from Fushimi Pharmaceutical Co., Ltd, Kagawa, Japan).

Very especially preferably, the flame retardant used is aluminium tris(diethylphosphinate), which is sold as Exolit® OP1240 (CAS No. 225789-38-8) by Clariant International Ltd, Muttenz, Switzerland.

### Component f)

According to the invention, at least one additive having at least two epoxy groups per molecule is used as component f). Preferred additives for component f) are selected from the group of the bisphenol diglycidyl ethers. Bisphenol diglycidyl ethers are obtained by reactions of bisphenol derivatives with epichlorohydrin. Preferred bisphenol components can be selected from the group of 2,2-bis(4-hydroxyphenyl)propane (bisphenol A), 1,1-bis(4-hydroxyphenyl)-1-phenylethane (bisphenol AP), bis(4-hydroxyphenyl) sulphone (bisphenol S) and bis(4-hydroxydiphenyl)methane (bisphenol F), particular preference being given to diglycidyl ethers based on bisphenol A. Very particular preference is given to solid bisphenol A diglycidyl ethers (CAS No. 1675-54-3) having a softening point above 60° C., for example Araldite® GT7071 from Huntsman, Everberg, Belgium.

### Component g)

The titanium dioxide for use as component g) (CAS No. 13463-67-7) preferably has a mean particle size in the range from 90 nm to 2000 nm (d50), the particle size distribution being determined by at least one method known to those skilled in the art, especially by means of the Debye-Scherrer method (see: http://de.wikipedia.org/wiki/Debye-Scherrer-Verfahren) or electron microscopy (TEM) (see: http://de.wikipedia.org/wiki/Transmissionselektronenmikroskop) with quantitative image processing.

Useful titanium dioxide pigments for the titanium dioxide for use in accordance with the invention as component g) include those whose base structures can be produced by the sulphate (SP) or chloride (CP) method, and which preferably have anatase (CAS No. 1317-70-0) and/or rutile structure (CAS No. 1317-80-2), more preferably rutile structure. The base structure need not be stabilized, but preference is given to a specific stabilization: in the case of the CP base structure by an Al doping of 0.3-3.0% by weight (calculated as Al₂O₃) and an oxygen excess in the gas phase in the oxidation of the titanium tetrachloride to titanium dioxide of at least 2%; in the case of the SP base structure by a doping, preferably with Al, Sb, Nb or Zn. More preferably, in order to obtain a sufficiently high brightness of the products to be produced from the compositions, a “light” stabilization with Al is preferred, or compensation with antimony in the case of higher amounts of Al dopant. In the case of use of titanium dioxide as white pigment in paints and coatings, plastics etc., it is known that unwanted photocatalytic reactions caused by UV absorption lead to breakdown of the pigmented material. This involves absorption of light in the near ultraviolet range by titanium dioxide pigments, forming electron-hole pairs, which produce highly reactive free radicals on the titanium dioxide surface. The free radicals formed result in binder degradation in organic media. Preference is given in accordance with the invention to lowering the photoactivity of the titanium dioxide by inorganic aftertreatment thereof, more preferably with oxides of Si and/or Al and/or Zr and/or through the use of Sn compounds.

Preferably, the surface of pigmentary titanium dioxide is covered with amorphous precipitated oxide hydrates of the compounds SiO₂ and/or Al₂O₃ and/or zirconium oxide. The Al₂O₃ shell facilitates pigment dispersion in the polymer matrix; the SiO₂ shell makes it difficult for charges to be exchanged at the pigment surface and hence reduces polymer degradation.

According to the invention, the titanium dioxide is preferably provided with hydrophilic and/or hydrophobic organic coatings, especially with siloxanes or polyalcohols.

Titanium dioxide for use as component g) in accordance with the invention preferably has a mean particle size in the range from 90 nm to 2000 nm, preferably in the range from 200 nm to 800 nm, these figures being based on the median particle size on the d50 value. According to the invention, the mean particle size is determined as described above.

Commercially available products are, for example, Kronos® 2230, Kronos® 2225 and Kronos® vlp7000 from Kronos, Dallas, USA.

### Component h)

According to the invention, at least one additive different from components c), d), e), f) and g) can be used as component h).

Customary additives for component h) are preferably stabilizers, demoulding agents, UV stabilizers, thermal stabilizers, gamma ray stabilizers, antistats, flow aids, flame retardants, elastomer modifiers, acid scavengers, emulsifiers, nucleating agents, plasticizers, lubricants, dyes or pigments. These and further suitable additives are described, for example, in Gächter, Müller, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives can be used alone or in a mixture, or in the form of masterbatches.

Stabilizers used are preferably sterically hindered phenols or phosphites, hydroquinones, aromatic secondary amines such as diphenylamines, substituted resorcinols, salicylates, benzotriazoles and benzophenones, and also variously substituted representatives of these groups or mixtures thereof.

Preferred phosphites are selected from the group of tris(2,4-di-tert-butylphenyl) phosphite (Irgafos® 168, BASF SE, CAS 31570-04-4), bis(2,4-di-tert-butylphenyl)pentaerythrityl diphosphite (Ultranox® 626, Chemtura, CAS 26741-53-7), bis(2,6-di-tert-butyl-4-methylphenyl)pentaerythrityl diphosphite (ADK Stab PEP-36, Adeka, CAS 80693-00-1), bis(2,4-dicumylphenyl)pentaerythrityl diphosphite (Doverphos® S-9228, Dover Chemical Corporation, CAS 154862-43-8), tris(nonylphenyl) phosphite (Irgafos® TNPP, BASF SE, CAS 26523-78-4), (2,4,6-tri-t-butylphenol)-2-butyl-2-ethyl-1,3-propanediol phosphite (Ultranox® 641, Chemtura, CAS 161717-32-4) and Hostanox® P-EPQ.

The phosphite stabilizer used is especially preferably at least Hostanox® P-EPQ (CAS No. 119345-01-6) from Clarlant International Ltd., Muttenz, Switzerland. This comprises tetrakis(2,4-di-tert-butylphenyl)-1,1-biphenyl-4,4′-diyl bisphosphonite (CAS No. 38813-77-3), which can especially be used with very particular preference as component d) in accordance with the invention.

Acid scavengers used are preferably hydrotalcite, chalk, zinc stannate or boehmite.

Preferred demoulding agents used are at least one selected from the group of ester wax(es), pentaerythrityl tetrastearate (PETS), long-chain fatty acids, salt(s) of the long-chain fatty acids, amide derivative(s) of the long-chain fatty acids, montan waxes and low molecular weight polyethylene or polypropylene wax(es), and ethylene homopolymer wax(es).

Preferred long-chain fatty acids are stearic acid or behenic acid. Preferred salts of long-chain fatty acids are calcium stearate or zinc stearate. A preferred amide derivative of long-chain fatty acids is ethylenebisstearylamide (CAS No. 130-10-5). Preferred montan waxes are mixtures of short-chain saturated carboxylic acids having chain lengths of 28 to 32 carbon atoms.

Further dyes or pigments are used as dyes or pigments, irrespective of the titanium dioxide in component c), for example, in order to give a hue to the light emitted in the case of an optoelectronic product, or to improve the light emitted by means of an optical brightener.

Nucleating agents used are preferably sodium phenylphosphinate or calcium phenylphosphinate, alumina (CAS No. 1344-28-1) or silicon dioxide.

Plasticizers used are preferably dioctyl phthalate, dibenzyl phthalate, butyl benzyl phthalate, hydrocarbon oils or N-(n-butyl)benzenesulphonamide.

Additive use for use as elastomer modifier is preferably one or more graft polymer(s) E of
E.1 5 to 95% by weight, preferably 30 to 90% by weight, of at least one vinyl monomer
E.2 95 to 5% by weight, preferably 70 to 10% by weight, of one or more graft bases having glass transition temperatures of <10° C., preferably <0° C., more preferably <−20° C.

The graft base E.2 generally has a median particle size (d₅₀) of 0.05 to 10 μm, preferably 0.1 to 5 μm, more preferably 0.2 to 1 μm.

Monomers E.1 are preferably mixtures of
E.1.1 50 to 99% by weight of vinylaromatics and/or ring-substituted vinylaromatics (for example styrene, α-methylstyrene, p-methylstyrene, p-chlorostyrene) and/or (C₁-C₈)-alkyl methacrylates (for example methyl methacrylate, ethyl methacrylate) and/or glycidyl (meth)acrylate and
E.1.2 1 to 50% by weight of vinyl cyanides (unsaturated nitriles such as acrylonitile and methacrylonitrile) and/or (C₁-C₈)-alkyl (meth)acrylates (for example methyl methacrylate, n-butyl acrylate, t-butyl acrylate) and/or glycidyl methacrylate and/or derivatives (such as anhydrides and imides) of unsaturated carboxylic acids (for example maleic anhydride and N-phenylmaleimide).

Preferred monomers E.1.1 are selected from at least one of the monomers styrene, α-methylstyrene, glycidyl methacrylate and methyl methacrylate; preferred monomers E.1.2 are selected from at least one of the monomers acrylonitrile, maleic anhydride and methyl methacrylate.

Particularly preferred monomers are E.1.1 styrene and E.1.2 acrylonitrile.

Graft bases E.2 suitable for the graft polymers for use in the elastomer modifiers are, for example, diene rubbers, EP(D)M rubbers, i.e. those based on ethylene/propylene, and optionally diene, acrylate, polyurethane, silicone, chloroprene and ethylene/vinyl acetate rubbers

Preferred graft bases E.2 are diene rubbers (for example based on butadiene, isoprene etc.) or mixtures of diene rubbers or copolymers of diene rubbers or mixtures thereof with further copolymerizable monomers (for example as per E.1.1 and E.1.2), with the proviso that the glass transition temperature of component E.2 is below <10° C., preferably <0° C., more preferably <−10° C.

A particularly preferred graft base E.2 is pure polybutadiene rubber.

Particularly preferred polymers E are ABS polymers (emulsion, bulk and suspension ABS), as described, for example, in DE-A 2 035 390 (=U.S. Pat. No. 3,644,574) or in DE-A 2 248 242 (=GB-A 1 409 275) or in Ullmann, Enzyklopädie der Technischen Chemie, vol. 19 (1980), p. 280 ff. The gel content of the graft base E.2 is at least 30% by weight, preferably at least 40% by weight (measured in toluene). ABS means acrylonitrile-butadiene-styrene copolymer with CAS number 9003-56-9 and is a synthetic terpolymer formed from the three different monomer types acrylonitrile, 1,3-butadiene and styrene. It is one of the amorphous thermoplastics. The ratios may vary from 15-35% acrylonitrile, 5-30% butadiene and 40-60% styrene.

The elastomer modifiers or graft copolymers E are prepared by free-radical polymerization, for example by emulsion, suspension, solution or bulk polymerization, preferably by emulsion or bulk polymerization.

Particularly suitable graft rubbers are also ABS polymers, which are prepared by redox initiation with an initiator system composed of organic hydroperoxide and ascorbic acid to U.S. Pat. No. 4,937,285.

Since, as is well known, the graft monomers are not necessarily grafted completely onto the graft base in the grafting reaction, according to the invention, graft polymers E are also understood to mean those products which are obtained through (co)polymerization of the graft monomers in the presence of the graft base and occur in the workup as well.

Suitable acrylate rubbers are based on graft bases E.2, which are preferably polymers of alkyl acrylates, optionally with up to 40% by weight, based on E.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, especially preferably chloroethyl acrylate, and mixtures of these monomers.

For crosslinking, it is possible to copolymerize monomers having more than one polymerizable double bond. Preferred crosslinking monomers are esters of unsaturated monocarboxylic acids having 3 to 8 carbon atoms and unsaturated monohydric alcohols having 3 to 12 carbon atoms, or esters of saturated polyols having 2 to 4 OH groups and 2 to 20 carbon atoms, especially ethylene glycol dimethacrylate, allyl methacrylate; polyunsaturated heterocyclic compounds, especially trivinyl cyanurate and triallyl cyanurate; polyfunctional vinyl compounds, especially di- and trivinylbenzenes, but also triallyl phosphate or diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinking monomers is preferably 0.02% to 5%, especially 0.05% to 2%, by weight, based on the graft base E.2.

In the case of cyclic crosslinking monomers having at least 3 ethylenically unsaturated groups, it is advantageous to restrict the amount to below 1% by weight of the graft base E.2.

Preferred “other” polymerizable, ethylenically unsaturated monomers which, alongside the acrylic esters, may optionally serve for preparation of the graft base E.2 are especially acrylonitrile, styrene, α-methylstyrene, acrylamide, vinyl C₁-C₆-alkyl ethers, methyl methacrylate, butadiene. Preferred acrylate rubbers as graft base E.2 are emulsion polymers having a gel content of at least 60% by weight.

Further suitable graft bases according to E.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Irrespective of component c), additional fillers and/or reinforcers may be present as additives in the inventive compositions.

Preference is also given to a mixture of two or more different fillers and/or reinforcers, especially based on mica, silicate, quartz, wollastonite, kaolin, amorphous silicas, magnesium carbonate, chalk, feldspar, barium sulphate, glass beads and/or fibrous fillers and/or reinforcers based on carbon fibres. Preference is given to using mineral particulate fillers based on mica, silicate, quartz, wollastonite, kaolin, amorphous silicas, magnesium carbonate, chalk, feldspar or barium sulphate. Particular preference is given in accordance with the invention to using mineral particulate fillers based on wollastonite or kaolin.

Particular preference is additionally also given to using acicular mineral fillers as an additive. Acicular mineral fillers are understood in accordance with the invention to mean a mineral filler with a highly pronounced acicular character. One example is acicular wollastonites. The mineral filler preferably has a length:diameter ratio of 2:1 to 35:1, more preferably of 3:1 to 19:1, most preferably of 4:1 to 12:1. The particle size determination and distribution are effected here typically by dynamic light scattering, ultracentrifuge or field flow fractionation. The median particle size d50 of the acicular mineral fillers for use as component h) Is preferably less than 20 μm, more preferably less than 15 μm, especially preferably less than 10 μm, determined in the context of the present invention with a CILAS GRANULOMETER in analogy to ISO 13320:2009 by means of laser diffraction.

As already described above for component c), in a preferred use form, the filler and/or reinforcer may have been surface-modified, more preferably with an adhesion promoter or adhesion promoter system, especially preferably based on silane. However, the pretreatment is not absolutely necessary.

For the modification of the fillers for use as component h), the silane compounds are generally used in amounts of 0.05% to 2% by weight, preferably 0.25% to 1.5% by weight and especially 0.5% to 1% by weight, based on the mineral filler for surface coating.

As a result of the incorporation of the fillers for use as components c) and h) into the polymer, the lengths and diameters mentioned in the context of the present invention may vary, which is why the lengths and diameters are specified above prior to mixing with the polymer. For example, the shear forces that occur in the extruder may divide or agglomerate the filler. This applies to all the particulate fillers mentioned in the context of the present invention, which, as a result of processing to give the moulding composition or shaped body, have a smaller d97 or d50 in relation to length and diameter in the moulding composition or in the shaped body than the fillers originally used.

In a preferred embodiment, the present invention relates to compositions comprising a) poly(1,4-cyclohexylenedimethylene) terephthalate, preferably having a viscosity of 110 g/cm³, b) PET, c) glass fibres, d) talc and e) aluminium tris(diethylphosphinate).

In a preferred embodiment, the present invention relates to compositions, especially moulding compositions and products that can be produced therefrom, comprising a) poly(1,4-cyclohlexylenedimethylene) terephthalate (PCT), preferably having a viscosity of 110 g/cm³, b) polyethylene terephthalate (PET), c) glass fibres, d) talc, preferably microcrystalline talc, e) aluminium tris(diethylphosphinate) and h) pentaerythrityl tetrastearate (CAS No. 115-83-3).

### Use

The present invention also relates to the use of the inventive compositions, especially in the form of moulding compositions, for production of products resistant to heat distortion for short periods, preferably electric or electronic assemblies and components, especially preferably optoelectronic products.

The present invention also relates to the use of the inventive compositions for enhancing the short-term heat distortion resistance of products, preferably of products in the electrics or electronics industry, especially electronic products for circuit boards, for example housings for coil formers, plug connectors or capacitors, and power transistors, and also of optoelectronic products.

### Process

Moulding compositions for use in accordance with the invention for injection moulding or for extrusion are obtained by mixing the individual components of the inventive compositions, discharging them to form an extrudate, cooling the extrudate until it is pelletizable and pelletizing it.

Preference is given to mixing at temperatures in the range from 260 to 310° C., preferably in the range from 270 to 300° C., more preferably in the range from 280 to 295° C., in the melt. Especially preferably, a twin-shaft extruder is used for this purpose.

In one embodiment, the pelletized material comprising the inventive composition is dried, preferably at temperatures in the region of 120° C. in a vacuum drying cabinet or in a dry air dryer, for a period in the region of 2 h, before it is subjected to an injection moulding or extrusion process in the form of a matrix material for the purpose of producing products.

The present Invention also relates to a process for producing products, preferably products resistant to heat distortion for short periods, preferably for the electrics or electronics industries, more preferably electronic or electric assemblies and components, by mixing inventive compositions, discharging them to form a moulding composition in the form of an extrudate, cooling the extrudate until it is pelletizable and pelletizing it, and subjecting the pelletized material in the form of a matrix material to an injection moulding or extrusion operation, preferably an injection moulding operation.

The present invention also relates to a process for improving the short-term heat distortion resistance of polyester-based products, characterized in that inventive compositions in the form of moulding compositions are processed by means of injection moulding or extrusion in the form of a matrix material.

The processes of injection moulding and extrusion of thermoplastic moulding compositions are known to those skilled in the art.

Inventive processes for producing products by extrusion or injection moulding work at melt temperatures in the range from 260 to 330° C., preferably in the range from 270 to 300° C., more preferably in the range from 280 to 290° C., and optionally additionally at pressures of not more than 2500 bar, preferably at pressures of not more than 2000 bar, more preferably at pressures of not more than 1500 bar and most preferably at pressures of not more than 750 bar.

Sequential coextrusion involves expelling two different materials successively in alternating sequence. In this way, a preform having different material composition section by section in extrusion direction is formed. It is possible to provide particular article sections with specifically required properties through appropriate material selection, for example for articles with soft ends and a hard middle section or integrated soft bellows regions (Thielen, Hartwig, Gust, “Biasformen von Kunstsoffhohlkörpern” [Blow-Moulding of Hollow Plastics Bodies], Carl Hanser Verlag, Munich 2006, pages 127-129).

The process of injection moulding features melting (plasticization) of the raw material, preferably in pellet form, in a heated cylindrical cavity, and injection thereof as an injection moulding material under pressure into a temperature-controlled cavity. After the cooling (solidification) of the material, the injection moulding is demoulded.

The following stages are distinguished:

### 1. Plasticization/melting

2. Injection phase (filling operation)
3. Hold pressure phase (owing to thermal contraction in the course of crystallization)

### 4. Demoulding.

An injection moulding machine consists of a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mould, the incoming melt is then separated and cooled, and hence the product to be produced is produced. Two halves of the mould are always needed for this purpose. In injection moulding, the following functional systems are distinguished:
runner system
shaping inserts
venting
machine casing and force absorber
demoulding system and movement transmission
temperature control

In contrast to injection moulding, extrusion uses a continuous shaped polymer extrudate, a polyamide here, in the extruder, the extruder being a machine for producing shaped thermoplastics. A distinction is made between single-screw extruders and twin-screw extruders, and also the respective sub-groups of conventional single-screw extruders, conveying single-screw extruders, contra-rotating twin-screw extruders and co-rotating twin-screw extruders.

Extrusion systems consist of extruder, mould, downstream equipment, extrusion blow moulds. Extrusion systems for production of profiles consist of: extruder, profile mould, calibration, cooling zone, caterpillar take-off and roll take-off, separating device and tilting chute.

The present invention consequently also relates to products, especially to products resistant to heat distortion for short periods, obtainable by extrusion, preferably profile extrusion, or injection moulding of the moulding compositions obtainable from the inventive compositions.

The present invention preferably relates to a process for producing products resistant to heat distortion for short periods, characterized in that the above compositions, preferably compositions comprising
a) 3 to 30% by weight, preferably 5 to 25% by weight, more preferably 10 to 20% by weight, of poly(1,4-cyclohexylenedimethylene) terephthalate (PCT), where the proportion of PCT based on the sum total of all the thermoplastic polymers present in the composition is in the range from 5 to 40% by weight, preferably 7 to 30% by weight, more preferably 10-25% by weight,
b) 15 to 91.99% by weight, preferably 20 to 70% by weight, more preferably 30 to 60% by weight, of polyethylene terephthalate (PET),
c) 5 to 70% by weight, preferably 10 to 45% by weight, more preferably 15 to 35% by weight, of glass fibres, and
d) 0.01 to 10% by weight, preferably 0.05 to 5% by weight, more preferably 0.1 to 2% by weight, of talc, preferably microcrystalline talc,
   where the individual components should be combined with one another in such a way that the sum total of all the percentages by weight is 100, are mixed, discharged to give a moulding composition in the form of an extrudate, the extrudate is cooled until it is pelletizable and pelletized, and the pelletized material is subjected to an injection moulding or extrusion operation.

The products obtainable by the processes mentioned surprisingly exhibit excellent short-term heat distortion resistance, especially in soldering operations, and optimized properties in the mechanical properties. The moulding compositions that can be produced from the inventive compositions for injection moulding and extrusion additionally feature good processability compared to the prior art.

The products produced in the inventive manner are therefore also of excellent suitability for electric or electronic products, preferably optoelectronic products, especially LEDs or OLEDs.

A light-emitting diode (also called luminescence diode, LED) is an electronic semiconductor component. If current flows through the diode in forward direction, it emits light, infrared radiation (in the form of an infrared light-emitting diode) or else ultraviolet radiation with a wavelength dependent on the semiconductor material and the doping. An organic light-emitting diode (OLED) is a thin-film light-emitting component composed of organic semiconductor materials, which differs from the inorganic light-emitting diodes (LEDs) in that the current density and luminance are lower, and monocrystalline materials are not required. Compared to conventional (inorganic) light-emitting diodes, organic light-emitting diodes are therefore less expensive to produce, but their lifetime is currently shorter than the conventional light-emitting diodes.

### EXAMPLES

To produce the compositions described in accordance with the invention, the individual components were mixed in a twin-shaft extruder (ZSK 26 Mega Compounder from Coperion Wemer & Pfleiderer (Stuttgart, Germany with 3-hole die plate and a die hole diameter of 3 mm) at temperatures between 280 and 295° C. in the melt and discharged as an extrudate, and the extrudate was cooled until pelletizable and pelletized. Before further steps, the pelletized material was dried at 120° C. in a vacuum drying cabinet for about 2 h. At this time, processability was assessed qualitatively as a function of temperature: “+” represents problem-free processing, “o” restricted processability, for example owing to a sharply rising die pressure or the breakdown of sensitive additives.

The sheets and test specimens for the studies listed in Table 1 were injection-moulded on a conventional injection moulding machine at a melt temperature of 280-290° C. and a mould temperature of 80-120° C. A characteristic parameter for the quality of the injection moulding operation in the context of the present invention was demouldability: for demouldability, rapid crystallization is advantageous, in order to be able to eject the product from the mould very quickly and without deformation. In the examples and comparative examples shown in Table 1, “+” represents good demouldability, “o” satisfactory demouldability and “−” poor demouldability.

### Short-Term Heat Distortion Resistance

The test for determining melt stiffness as a measure of short-term heat distortion resistance or solder bath resistance simulates the conditions of wave soldering as follows:

From a sheet having a thickness of 1.0 mm, test specimens of dimensions 20·10·1 mm were cut out. These were introduced into a conventional hot air oven heated at the temperature specified in Table 1 for 15 min. Subsequently, the partial melting characteristics of the specimens were assessed visually. “+” represents a sample with no visually observable partial melting, “o” a sample having rounded edges and “−” a sample that has partially melted over the entire surface.

### IZOD Impact Resistance

The determination of IZOD impact resistance was determined in analogy to ISO 180-1 on specimens of dimensions 80 mm·10 mm·4 mm.

### Flexural Strength, Edge Fibre Elongation

The testing of flexural strength and edge fibre elongation was effected in analogy to ISO 178 on specimens of dimensions 80 mm*10 mm*4 mm.

### Feedstocks

Component a): PCT [CAS No. 24936-69-4] having a viscosity of 110 g/cm³]
Component b): PET: polyethylene terephthalate (Polyester Chips PET V004, from Invista, Wichita, USA)
Component c): Glass fibres having a diameter of 10 μm, coated with a slip containing silane compounds (CS 7967, commercial product from Lanxess N.V., Antwerp, Belgium)
Component d): talc: Mistron® Rio from Imerys Talc Group, Toulouse, France (Rio Tinto Group)
Component e): aluminium tris(diethylphosphinate) Exolit® OP1240 from Clariant International Ltd., Mutlenz, Switzerland
Component h): further additives commonly used in polyesters, for example demoulding agents, especially pentaerythrityl tetrastearate (PETS), thermal stabilizers (for example based on phenyl phosphites). The type and amount of the additives referred to collectively as component H correspond in terms of type and amount for the examples and comparative examples.

Table 1 shows that, in the case of thermally sensitive flame retardants such as component e), only in the case of the inventive polyester blends are both good processibility and hence also good mechanical data and increased short-term heat distortion resistance found at temperatures above the melting point of component a. This is an important prerequisite for applications which, like electronic components for example, can be exposed briefly to solder bath temperatures up to 285° C.

TABLE 1
Polyester blends comprising thermally sensitive flame retardants
All the amounts of the components in Table 1 are in % by weight.

| | Comp. 1 | Comp. 2 | Comp. 3 | Ex. 1 | Ex. 2 |
|---|---|---|---|---|---|
| Component a) | | 40 | 53 | 10 | 15 |
| Component b) | 53 | 13 | | 43 | 38 |
| Component c) | 30 | 30 | 30 | 30 | 30 |
| Component d) | 0.5 | 0.5 | 0.5 | 0.5 | 0.5 |
| Component e) | 15 | 15 | 15 | 15 | 15 |
| Component h) | 1.5 | 1.5 | 1.5 | 1.5 | 1.5 |
| Processibility at 290° C. | + | ∘ | ∘ | + | + |
| Demouldability | + | − | ∘ | + | + |
| Melt stiffness at 265° C. | + | + | + | + | + |
| Melt stiffness at 275° C. | ∘ | + | + | + | + |
| Melt stiffness at 285° C. | − | + | + | + | + |
| IZOD [kJ/m²] | + | − | − | + | + |
| Flexural strength [MPa] | + | − | − | + | + |
| Edge fibre elongation [%] | + | − | − | + | + |

What is claimed is:

1. Compositions comprising
a) poly(1,4-cyclohexylenedimethylene) terephthalate (PCT),
b) polyethylene terephthalate (PET),
c) glass fibres, and
d) talc.

2. Compositions according to claim 1, characterized in that they comprise
a) 3 to 30% by weight of poly(1,4-cyclohexylenedimethylene) terephthalate (PCT), where the proportion of PCT based on the sum total of all the thermoplastic polymers present in the composition is in the range from 5 to 40% by weight,
b) 15 to 91.99% by weight of polyethylene terephthalate (PET),
c) 5 to 70% by weight of glass fibres, and
d) 0.01 to 10% by weight of talc, where the individual components should be combined with one another in such a way that the sum total of all the percentages by weight is 100.

3. Compositions according to claim 2, characterized in that they comprise, in addition to components a), b), c) and d), also e) at least one flame retardant to an extent of 1 to 50% by weight, in which case the level of at least one of the other components should be reduced to such an extent that the sum total of all the percentages by weight is 100.

4. Compositions according to claim 3, characterized in that the flame retardants used are organic halogen compounds with or without synergists or halogen-free flame retardants based on organic or inorganic phosphorus compounds or organic nitrogen compounds, individually or in a mixture.

5. Compositions according to claim 4, characterized in that the organic halogen compounds used are ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ether.

6. Compositions according to claim 4, characterized in that the organic or inorganic phosphorus compounds used are metal phosphinates, especially aluminium phosphinate or zinc phosphinate, metal phosphonates, especially aluminium phosphonate, calcium phosphonate or zinc phosphonate and the corresponding hydrates of the metal phosphonates, and derivatives of the 9,10-dihydro-9-oxa-10-phosphaphenanthrene 10-oxides (DOPO derivatives), triphenyl phosphate (TPP), resorcinol bis(diphenyl phosphate) (RDP), including oligomers, and bisphenol A bis(diphenyl phosphate) (BDP) including oligomers, polyphosphonates, and also zinc bis(diethylphosphinate), aluminium tris(diethylphosphinate), melamine phosphate, melamine pyrophosphate, melamine polyphosphate, melamine poly(aluminium phosphate), melamine poly(zinc phosphate) or phenoxyphosphazene oligomers and mixtures thereof.

7. Compositions according to claim 4, characterized in that the organic nitrogen compounds used are melamine or melamine cyanurate and reaction products of trichlorotriazine, piperazine and morpholine.

8. Compositions according to claim 4, characterized in that the synergists used are antimony compounds, zinc compounds, tin compounds, or borates.

9. Compositions according to claim 6, characterized in that aluminium tris(diethylphosphinate) is used.

10. Compositions according to claim 8, characterized in that the synergists used are antimony trioxide, antimony pentoxide.

11. Compositions according to claim 3, characterized in that they comprise, in addition to components a) to e) or instead of component e), also f) at least one additive having two epoxy groups per molecule, to an extent of 0.01 to 15% by weight, in which case the level of at least one of the other components should be reduced such that the sum total of all the percentages by weight is 100.

12. Compositions according to claim 11, characterized in that component f) is a bisphenol diglycidyl ether.

13. Compositions according to claim 11, characterized in that they comprise, in addition to components a) to f) or instead of components e) and/or f), also g) titanium dioxide, to an extent of 0.01 to 30% by weight, in which case the level of at least one of the other components should be reduced such that the sum total of all the percentages by weight is 100.

14. Compositions according to claim 13, characterized in that they comprise, in addition to components a) to g) or instead of components e) and/or f) and/or g), also h) at least one other additive different from components c) to g), to an extent of 0.01 to 15% by weight, in which case the level of at least one of the other components should be reduced such that the sum total of all the percentages by weight is 100.

15. A mold comprising the compositions according to claim 1.

16. Process for producing products resistant to heat distortion for short periods, characterized in that compositions according to claim 1 are mixed, discharged to give a moulding composition in the form of an extrudate, the extrudate is cooled until it is pelletizable and pelletized, and the pelletized material is subjected to an injection moulding or extrusion operation in the form of a matrix material.

17. Compositions according to claim 8, characterized in that the synergists used are zinc stannate.

18. Compositions according to claim 8, characterized in that the synergists used are zinc borates.

19. Compositions according to claim 12 wherein component f) is selected from the group of 2,2-bis(4-hydroxyphenyl)propane, 1,1-bis(4-hydroxyphenyl)-1-phenylethane, bis(4-hydroxyphenyl)sulphone and bis(4-hydroxydiphenyl)methane.
